(19) United States
(12) Patent Application Publication
(10) Pub. No.: US 2003/0087678 A1
(43) Pub. Date: May 8, 2003

(54) Energy conservation system

(76) Inventors: Sheldon D. Smith, Grosse Pointe Farms, MI (US); Shary Nassimi, Vancouver, WA (US); Harold B. Kennedy, Orange, CA (US); Donald Seefried, Palm Desert, CA (US)

Correspondence Address: Gifford, Krass, Groh, Sprinkle,, Anderson & Citkowski, P.C., Suite 400, 280 N. Old Woodward, Birmingham, MI, 48009, US

(21) Appl. No.: 10/054,310

(22) Filed: Jan. 22, 2002

Related U.S. Application Data
(60) Provisional application No. 60/263,670, filed on Jan. 23, 2001.

(51) Int. Cl. H04M 1/00; H04B 1/38

(52) U.S. Cl. 455/574; 455/572

(57) ABSTRACT

A room energy conservation system has a radio frequency transmitter located within a master controller. When an occupant leaves the room, the radio frequency transmitter communicates to a remote receiver to limit the electrical power available from a coupled electrical switch.

### RELATED APPLICATION

This application claims priority of U.S. Provisional Patent Application 60/263,670 filed Jan. 23, 2001, and is incorporated herein by reference.

### FIELD OF THE INVENTION

The present invention relates generally to energy conservation, and more particularly, to lowering energy consumption in an unoccupied room.

### BACKGROUND OF THE INVENTION

As the environmental and economic costs of energy consumption become more apparent, more attention has been paid to energy conservation. Energy conservation not only saves the consumer money, but also limits the societal need for additional power generation facilities and their associated economic and environmental costs. In conserving energy, the least drastic behavioral measures are associated with eliminating wasted consumption; consumption that affords the consumer little, if any, benefit.

The lodging industry maintains large numbers of self-contained rooms each having separate thermostats and electrical outlets. A lodging patron often leaves a room for hours at a time in a state of high energy consumption through climate control settings and operation of electrical appliances and lights. In such an instance, the lodging patron, absent from the room, derives no benefit from additional energy consumption. Energy consumption represents 3 to 6 percent of the gross revenue in the lodging industry. Lodging Magazine, October 2000, which is incorporated herein by reference.

Prior art attempts to limit energy consumption in vacant or unoccupied lodging rooms utilized a door keycard inserted into an electrical controller. The electrical controller of this prior art system required retrofitting hardwired systems that control electrical switches within the room. The labor and room downtime associated with such a hardwiring retrofit has limited the acceptance of this prior art system. Thus, there exists a need for a lodging energy conservation system operative without resort to a hardwiring retrofit installation of a master controller and controlled electrical power sources.

### SUMMARY OF THE INVENTION

The objective of the present invention is to provide an energy conservation system primarily for the purpose of lowering energy consumption in an unoccupied room within a lodging facility or the like. The system comprises a master controller which houses a radio frequency transmitter and an electrically controlled power device that houses a radio frequency receiver that is coupled to an electrical switching circuit. When activated, the master controller transmits a frequency that is received by the remote receiver. The received signal causes the switching circuit to connect to an energy source thereby providing power to an appliance connected to the controlled power device.

Preferably, the housings of the master controller and the controlled power device are dimensioned for installation within a conventional switch electrical box. The controller housing includes a key card slot adapted to allow the controller to be activated by a room occupant upon entering a room by inserting a keycard into the slot. Conversely, the controller is deactivated when the key card is removed from the slot.

The radio frequency transmitter within the controller emits a frequency that is received by the radio frequency receiver that is mounted at a remote location within range of the transmitter. Preferably, both the transmitter and receiver include a frequency modulation switch that allows for selection of one of a plurality of transmit and receive frequencies.

The receiver activates the electrical switching circuit upon receiving the signal from the master controller. In turn, the activation of the switching circuit causes the controlled power device to be connected to an energy source until the master controller is deactivated.

### BRIEF DESCRIPTION OF THE DRAWINGS

FIG. 1 is a top view of a conventional lodging room fitted with the present invention;

FIG. 2 is a perspective view of a master controller according to the present invention;

FIG. 2A is a schematic illustration of a master controller according to the present invention showing the internal components thereof;

FIG. 3 is a perspective side view of a master controller according to the present invention showing the internal components thereof;

FIG. 4 is a perspective view of a master controller according to the present invention with the removal of the faceplate therefrom;

FIG. 5 is a perspective view of a dual receptacle outlet according to the present invention;

FIG. 5A is a schematic illustration of a dual receptacle outlet according to the present invention;

FIG. 6 is a perspective view of the outlet shown in FIG. 5 absent the first housing portion;

FIG. 7 is an internal perspective view of the second housing portion of the outlet depicted in FIG. 5;

FIG. 8 is an internal perspective view of the first housing portion of the outlet depicted in FIG. 5; and

FIG. 9 is a schematic illustration of a thermo controller unit.

### DESCRIPTION OF THE PREFERRED EMBODIMENTS

The present invention has utility in conserving electrical energy in a vacant or unoccupied room. While the present invention as detailed herein is described with respect to a lodging guest room, it is appreciated to also be operative in the settings illustratively including hospitals, warehouses, commercial spaces, and residences.

The present invention has a master controller that upon activation by an occupant energizes a remote switching circuit that causes energy to be supplied to a controlled power device from an energy source that illustratively includes a natural gas feed; an electrical source; or water supply line. A controlled power device may include an electrical outlet; a climate-control component such as a thermostat or similar HVAC component; an electrical switch; a solenoid controlled valve; and the like. The master controller activates the switching circuit that is remote therefrom by sending a radio frequency (RF) signal to an RF receiver coupled to a switch circuit that in turn connects the energy source. The present invention operates in contrast to the prior art by communicating between the master controller and the remote energy supply sources through a radio frequency signal, as compared to conductive wiring physically forming connections therebetween.

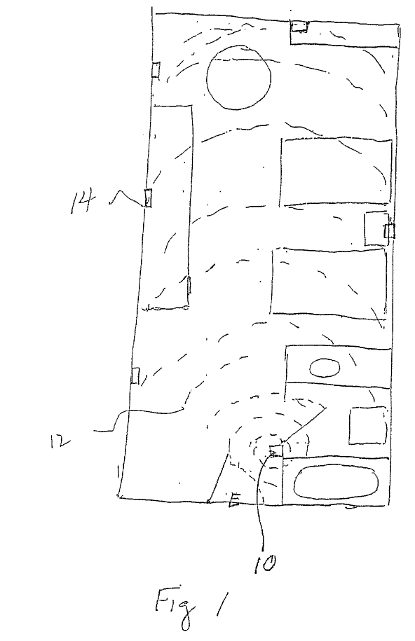

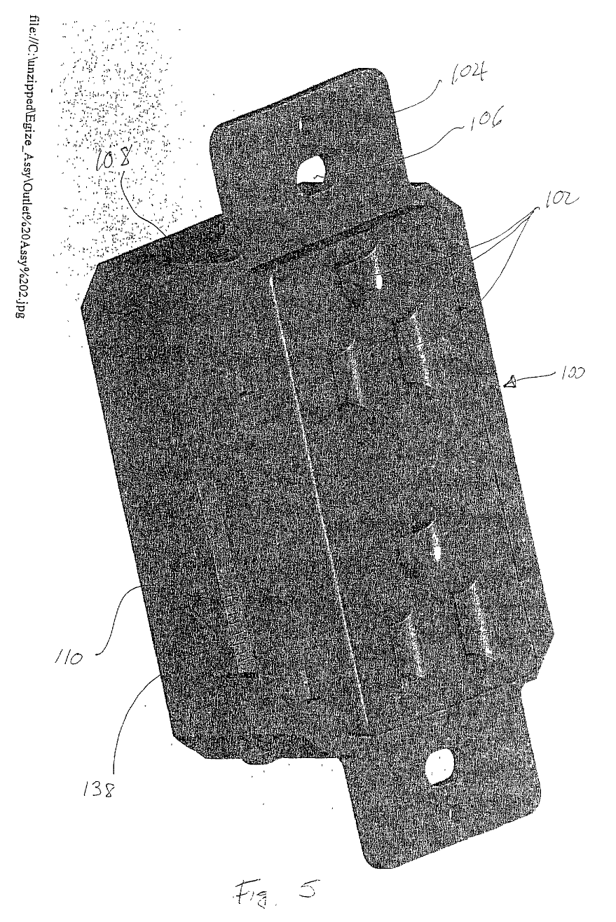

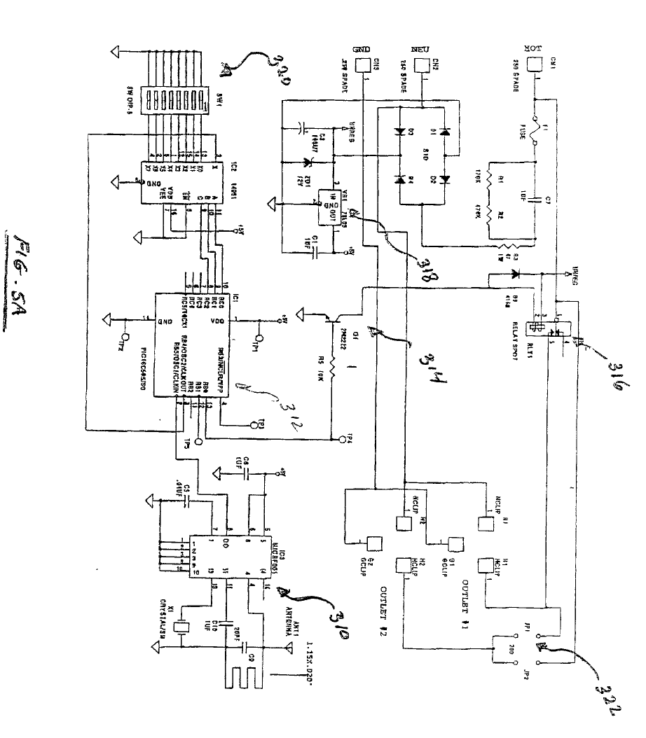

Referring now to FIG. 1, a master controller 10 of the present invention is mounted within a conventional lodging facility room. Preferably, the master controller 10 is mounted proximal to the room entryway E. The master controller is activated by a room occupant action. Room occupant actions illustratively including flipping a switch, producing a thermal signature, voice activation, inserting an entryway E key, touch pad activation, or inserting a keycard into the master controller 10. In a preferred embodiment, a keycard is inserted into the master controller 10 to cause activation thereof. The activated master controller 10 emits a radio frequency over a broadcast range encompassing remote RF receivers within a predetermined area. A broadcast range of 50-70 feet is typical in a lodging setting where the master controller radio frequency need only broadcast to tuned RF receivers within a lodging room. The RF frequency 12 is received by at least one RF receiver 14 located within the broadcast range of the master controller 10. The RF receiver 14 is remote from the master controller 10 and coupled to an electrical switching circuit that when activated causes an energy source to be coupled to a controlled power device. As depicted in FIG. 1, the RF receiver is coupled to an electrical outlet. FIG. 5A illustrates a schematic drawing of a controlled power device, namely the electrical outlet (or dual receptacle) of FIG. 5, wherein the switching circuit includes a SPST relay 316 coupled to the RF receiver 310 via a processor 312 and bipolar transistor 314. It is appreciated that additional energy or power sources in the lodging setting also include electrical switches, HVAC components such as thermostats, solenoid controlled valves, internet and cable TV jacks, and the like.

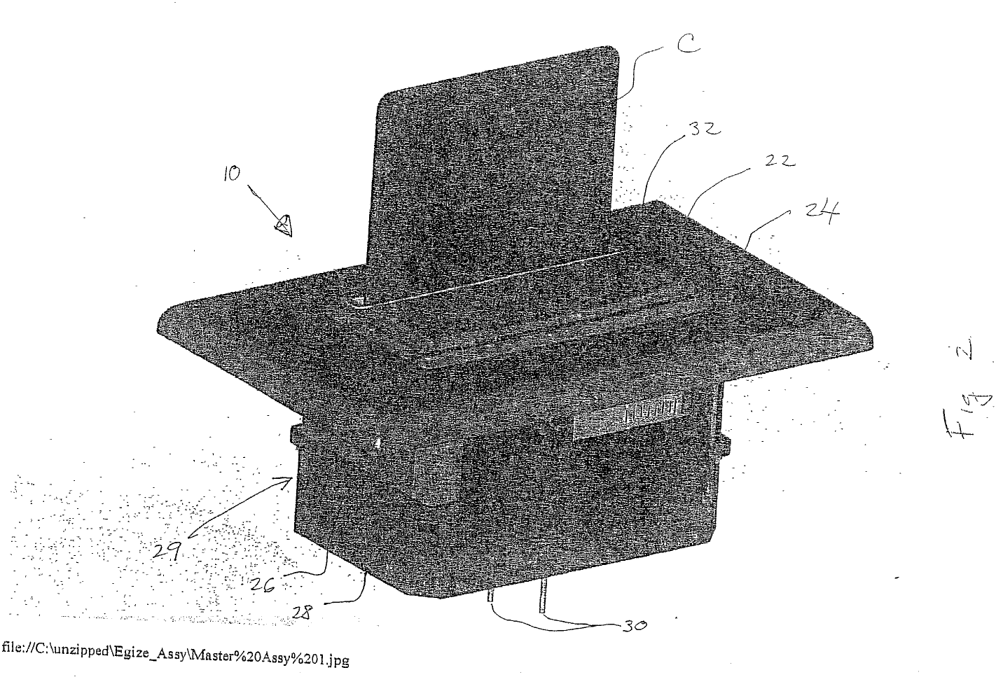

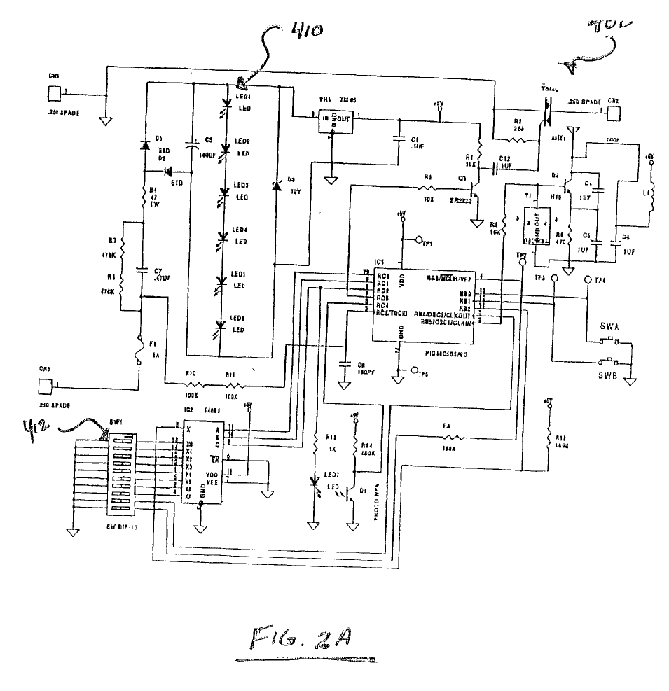

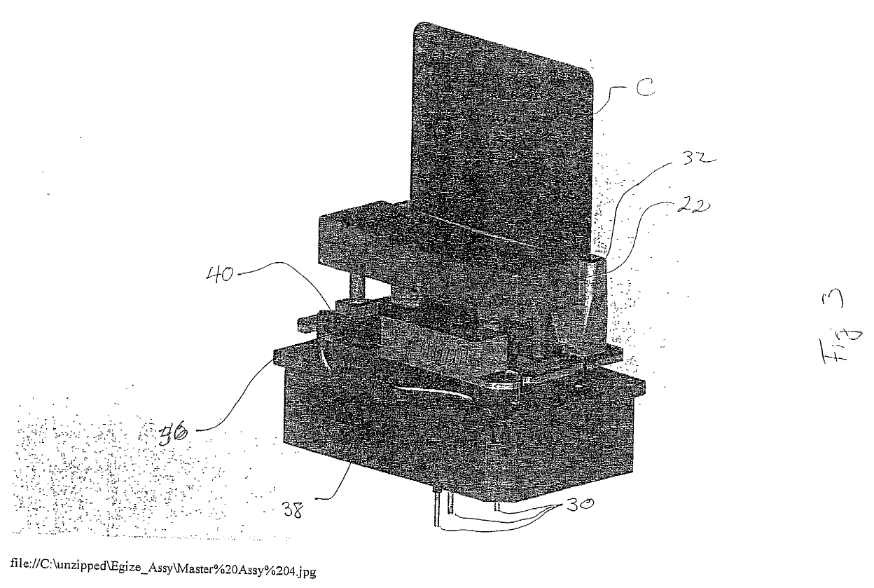

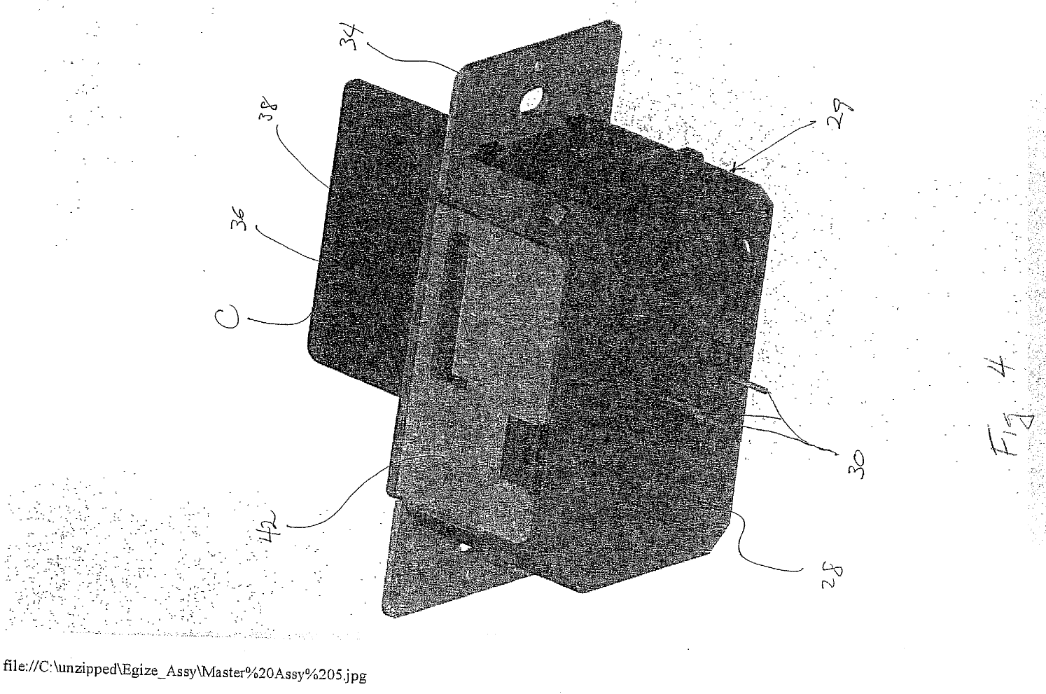

FIGS. 2, 3 and 4 illustrate in various views a preferred embodiment of a master controller 10 according to the present invention, where like number references among the figures refer to the same component. The master controller 10 as shown in FIG. 2 is incorporated into a conventional wall switch. The wall switch having a toggle rocker 22 and a conventional faceplate 24. A master controller top case portion 26 and master controller bottom housing portion 28 afford a rugged and self-contained unit promoting quick installation within a conventional switch electrical box. Extending from the master controller housing defined by top portion 26 and bottom portion 28 are electrical leads 30. Provided within the top portion 26 is an aperture 32 adapted to receive an activation card C. In a preferred embodiment, the aperture 32 is a translucent light pipe affording illumination of the aperture 32 even in a master controller deactive state in order to facilitate room occupant locating of the aperture 32. FIG. 2A illustrates a plurality of LEDs located within the housing defined by master controller portions 26 and 28 that provide a long lifetime, low intensity source of illumination. The light source is illustratively a light emitting diode but a phosphor or other illuminate material may be used that allows for the card slot to be visible when a room is dark. The housing 29 is fitted with a flange 34 adapted to receive at least one fastener for securing the master controller 10 within a conventional switch electrical box. A radio frequency emitting source 36 is provided within the housing 29. Preferably, the radio frequency source 36 is a radio frequency crystal but may be comprised of a combination of passive and active electronic components, a surface acoustic wave circuit, or other transmitter circuits suitable for low-power, close range transmission. More preferably (see FIG. 2A for schematic representation), the radio frequency source 36 is provided with a series of coding switches 412 for the setting of the specific frequency modulation. The radio frequency modulation switches 38 are still more preferably accessible without resort to disassembly of the housing 29. As shown in FIG. 2A, circuit board 400 contains conventional electronic components associated with an RF transmitter. It is appreciated that the RF broadcast range of a master controller 10 according to the present invention is affected by factors illustratively including the power input to the RF crystal, the materials the radio frequency must penetrate, and the specific radio frequency of the device. Preferably, a protective flange 42 affords mechanical protection to the exposed switches 38 of the radio frequency source 36.

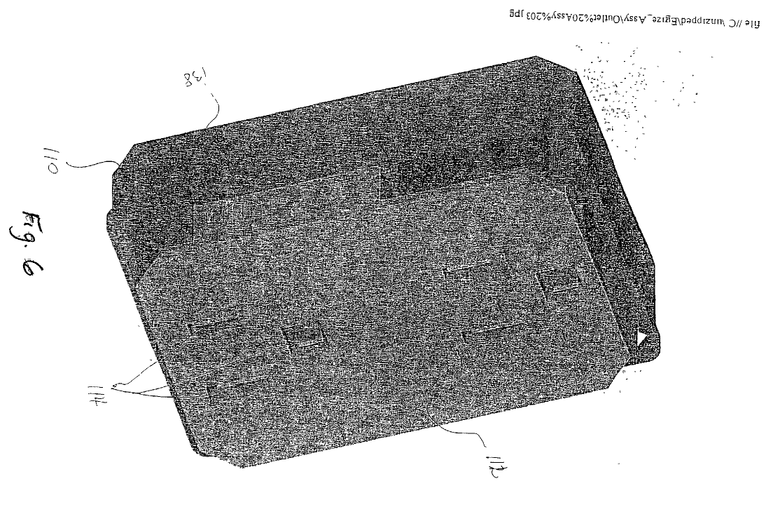

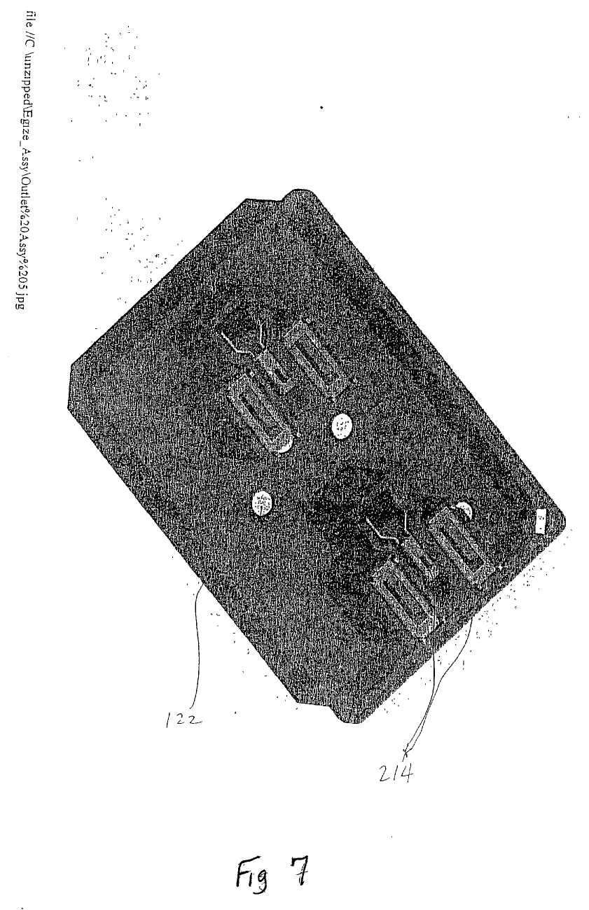

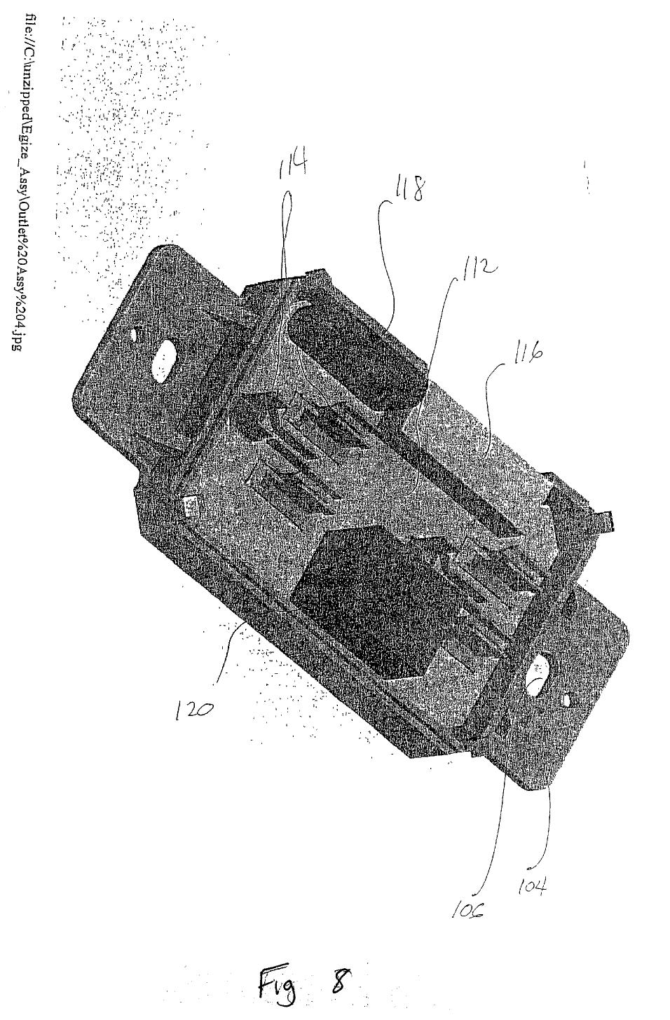

FIGS. 5-8 afford various views of an electrical outlet 100 according to the present invention including a schematic depiction in FIG. 5A of an RF receiver 310 and deactivating circuitry 318, where like number references among the figures refer to the same component. In FIG. 5, an electrical outlet 10 according to the present invention has conventional receptacle apertures 102 adapted to receive a conventional electrical plug. A flange 104 having an aperture 106 is adapted to secure to a conventional electrical box by way of a fastener (not shown). The outlet 100 is defined by a first housing portion 108 and a second housing portion 110. Within the first housing portion 108, an electrically insulating plate 112 is found. Beneath the plate 112 contacts collectively shown at 114 are provided for an electrical plug inserted therethrough. A radio frequency receiver 116 is attached to the plate 112. Preferably, the radio frequency receiver 116 is provided with frequency controlling switches, 138 and 320 respectively in FIGS. 5 and 5A, are intended to frequency code the radio frequency receiver 116 with the radio frequency signal emitted by the radio frequency transmitter 38 of master controller 10, as shown in FIGS. 1-4. In this way, proximate rooms are coded differently to avoid RF signaling interference. A power supply 118 for the radio frequency receiver 116 is also provided. Upon radio frequency receiver 116 receiving a signal from the master controller 10, a switching circuit 120 activates the conductive pathway through conductors 114. It is appreciated that in the embodiment depicted in FIGS. 5-8, only a single outlet receptacle of the dual receptacle is under the control of radio frequency activation. In this embodiment of an outlet according to the present invention, the conventional outlet receptacle remains active regardless of radio frequency signals and is adapted to controlled power devices such as a clock or other continuous operation device. The second outlet portion 110 provides complementary conductor portions 214 to conductors 114 located within first portion 108. As illustrated in FIG. 5A, the first and second portion may be jumpered 322 together such that both portions are activated by the master controller. Second portion 110 is also provided with apertures 122 through which electrical wire is received and thereby conductively coupled to connectors 214.

In operation, the present invention upon activation by a room occupant the master controller transmits a signal to the radio frequency receiver thereby activating the electrical outlet. Upon the room occupant, or final room occupant when a group is present, vacating the room, the keycard is removed from the master controller thereby terminating the radio frequency emissions from the master controller that in turn deactivates the remote outlet through the termination of receipt of the activating radio frequency. In a preferred embodiment, the master controller operates to afford continued radio frequency emission for a limited period of time after deactivation. The limited time of continued activation is typically between a few seconds and a few minutes.

While the present invention has been detailed with respect to an RF receiver controlling the energization of an electrical outlet, it is appreciated that the same RF receiver and switching circuitry can be coupled to other energy sources. In the case of the controlled power device being an HVAC component, it is often preferred not to completely shut down an HVAC system, but rather to switch to an energy conservation mode. An energy conservation mode for HVAC is provided by the present invention through incorporating a thermostat controller unit (TCU) within a master controller such that when the master controller is in a deactivated state, the master controller thermostat maintains HVAC control and upon master controller activation by a room occupant, HVAC control is transferred to a room occupant regulatable thermostat. The TCU may be in the form of a discrete modular unit that includes an RF receiver and HVAC control circuitry capable of controlling operation of the HVAC system in response to receiving an RF transmission from a master controller and according to preset conditions.

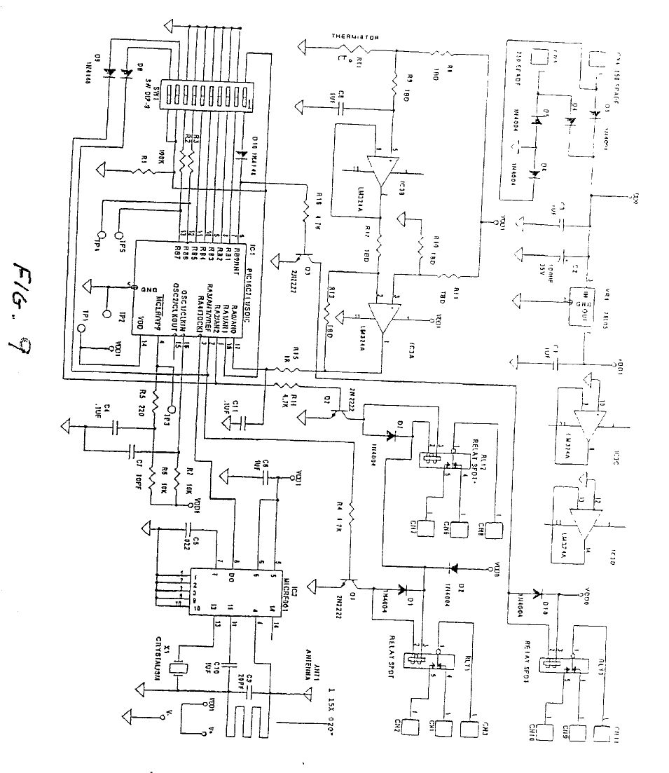

The modular TCU can be set to one of a plurality of control ranges that operate to limit the climate conditions within a room within the selected control range. Each control range includes distinct climate conditions to be maintained when the room is either occupied or unoccupied. An illustrative example being that when a room is occupied, the climate conditions within the room are limited between 67-73° F. while an unoccupied room would have climate conditions between 60-80° F. FIG. 9 schematically illustrates the sub-circuits within the TCU that include a dip switch used for selecting the mode of operation of the unit, an RF receiver circuit, and a plurality of SPST relays which operate to open and close the control circuits to the existing HVAC system. It is appreciated that incorporating a microprocessor into the present invention affords greater system programmability and flexibility in operation. For instance, seasonal or diurnal controller adjustments are facilitated in this way.

One skilled in the art to which the invention pertains will readily appreciate that various modifications of the present invention as detailed herein are possible without departing from the spirit of the invention. These modifications and all equivalents thereto are intended to fall within the scope of the appended claims.

1. An energy conservation system comprising:
a master controller activated by a room occupant action;
a radio frequency transmitter located within said master controller and having a broadcast range;
a radio frequency receiver remote from said radio frequency transmitter and coupled to an electrical switching circuit responsive to a radio frequency signal received from said radio frequency transmitter; and
a controlled power device coupled to the electrical switching circuit such that the device is coupled to an energy source upon activation of said master controller.

2. The energy conservation system of claim 1 wherein said master controller in a deactivated state causes said electrical switching circuit to deactivate said controlled power device.

3. The system of claim 1 wherein the master controller is mounted within a lodging room proximal to an entryway.

4. The system of claim 1 wherein the room occupant action that activates said master controller is insertion of a card into said master controller.

5. The system of claim 1 wherein said radio frequency transmitter is a crystal.

6. The system of claim 1 further including a thermostat control unit.

7. The system of claim 1 wherein the radio frequency transmitter further comprises a frequency modulation switch that allows for the transmitted frequency to be varied.

8. The system of claim 1 wherein the electrical switching circuit is a relay.

9. The system of claim 1 wherein the electrical switching circuit is a power transistor.

10. A process of room energy conservation comprising the steps of:
activating a radio frequency transmitter upon a room occupant action within a room;
sending a radio frequency signal from said transmitter to a radio frequency receiver coupled to an electrical switching circuit within a controlled power device;
activating said controlled power device in response to the radio frequency signal being received by the receiver; and
deactivating the RF transmitter upon a room occupant action when leaving the room.

11. The process of claim 10 further comprising the step of:
modulating a thermostat control unit with a radio frequency signal.

12. The process of claim 10 wherein the master controller is mounted within a lodging room proximal to an entryway.

13. The process of claim 10 wherein the electrical switching circuit is a relay.

14. The process of claim 10 wherein the electrical switching circuit is a power transistor.

15. Use of a radio frequency signaling system as claimed in claim 1 to lessen energy consumption in a vacant room.
